(19) United States
(12) Patent Application Publication
(10) Pub. No.: US 2013/0335267 A1
(43) Pub. Date: Dec. 19, 2013

(54) DETECTING METHOD OF GPS CLOCK SIGNAL JUMP USING CARRIER PHASE MEASUREMENTS IN REAL-TIME

(71) Applicant: KOREA AEROSPACE RESEARCH INSTITUTE, Daejeon (KR)

(72) Inventors: Youn Jeong HEO, Daejeon (KR); Jeongho CHO, Daejeon (KR); Moon-Beom HEO, Daejeon (KR)

(73) Assignee: KOREA AEROSPACE RESEARCH INSTITUTE, Daejeon (KR)

(21) Appl. No.: 13/857,528

(22) Filed: Apr. 5, 2013

(30) Foreign Application Priority Data
Jun. 15, 2012 (KR) 10-2012-0064329

(51) Int. Cl. G01S 19/20

(52) U.S. Cl. CPC G01S 19/20
USPC 342/357.58

(57) ABSTRACT

Provided is a method of detecting GPS clock signal jump, comprising a data obtaining step of obtaining GPS carrier phase measurements from a GPS receiver and satellite orbits from IGS to detect the GPS clock signal jump; a GPS clock bias calculating step of eliminating errors included in the data obtained from the data obtaining step and calculating GPS clock bias; a Teager energy calculating step of applying a Teager energy operator to the GPS clock bias calculated with respect to each satellite in the GPS clock bias calculating step and calculating Teager energy to determine whether the GPS clock jump is occurred; and a GPS clock jump detecting step of checking whether a Teager energy is larger than a threshold value. Therefore, the present invention can effectively detect the GPS clock signal jump in real-time.

### CROSS-REFERENCE(S) TO RELATED APPLICATIONS

The present invention claims priority of Korean Patent Application No. 10-2012-0064329, filed on Jun. 15, 2012, which is incorporated herein by reference.

### BACKGROUND OF THE INVENTION

1. Field of the Invention

The present invention relates to a method of detecting GPS clock signal jump, and more particularly to a method of detecting GPS clock signal jump using carrier phase measurements in real-time, which can detect the GPS clock signal jump in real-time using carrier phase measurements when a GPS clock signal is suddenly jumped.

2. Description of Related Art

GPS (Global Positioning System) is a system for measuring position, velocity and time of an object, in which the position is measured on the basis of the signals received from navigation satellites when measuring the position using a GPS. Therefore, in case that an abnormal state occurs in the navigation satellite and the position measurement is thus performed with an erroneous signal received from the abnormal navigation satellite, it is inevitable that the performance of position measurement is deteriorated. Particularly, in the field of aviation, if the erroneous position information is obtained from the abnormal navigation satellite, it leads to a full-scale accident. Therefore, it is necessary that strict safety procedures are in the place.

The main cause of generating the erroneous satellite signal may be listed as follows: troubles of the satellite itself including errors or defects relevant to GPS clock, sudden state change in the troposphere and/or the ionosphere while the satellite signal is being transferred, and other influences due to various environments.

In order to provide precise time and position information, the navigation satellites are equipped with several cesium and rubidium atomic clocks. In the atomic clock, frequency drift is generated due to aging phenomenon as time goes by, and thus a bias with respect to GPS time as standard time does exist.

Therefore, in the MCS (Master Control Station), phase, frequency and frequency drift of the GPS atomic clock are uploaded daily and thus correction information of the GPS clock is provided to a user through a navigation message so that the user can obtain precise time and position information.

However, in the GPS atomic clock, frequency or phase jump is also occurred, and this jump phenomenon may be occurred by a device controlling command of the MCS or the influence of device characteristics. The error of the GPS clock may be forecasted previously or may be not at all. In case that the error is not forecasted at all, it has an influence on the GPS measurements, and if the erroneous information is directly used in a real-time application field requiring the precise position, a critical error may be accompanied.

Therefore, a method of detecting the abnormal state of the GPS clock has been actively studied. For example, there is proposed a new method in which average values of signals are compared and it is determined whether GPS clock signal jump is occurred. However, in this method, it takes a long time to detect whether the GPS clock signal jump is occurred. Also even though the GPS clock signal jump is detected, it is not possible to detect a certain time of the GPS clock signal jump.

As another example, there is a CUSUM (Cumulative Sum) method in which the GPS clock signal jump is detected by cumulating a difference between an input signal and an average value and observing a change in its slope. Herein, since the GPS clock jump is detected by cumulating the whole average values and thus the detecting speed is slow, it is technically limited to apply to the field of aviation which requires the precise position in real-time. Therefore, it is required to develop a method of detecting the GPS clock signal jump, which can detect the GPS clock signal jump in real-time.

The present inventors has reasoned and studied that it was possible to detect various situations such as frequency and phase jump in the GPS clock using Teager energy operator proposed by Teager et al. As a result, we has proposed a method of easily and exactly detecting the GPS clock signal jump in a research paper entitled “detection of GPS clock jump using Teager energy” (Journal of Korea aeronautical and space sciences, Vol. 38, No. 1, PP. 58-63, January 2010). This paper shows that it is possible to easily and precisely detect the GPS clock signal jump by applying the Teager energy to previously estimated GPS clock measurements, but does not provide a detailed method of detecting the GPS clock signal jump from GPS real-time measurements. Therefore, it is required to develop a method of detecting the GPS clock signal jump in real-time.

### SUMMARY OF THE INVENTION

An embodiment of the present invention is directed to providing a method of detecting GPS clock signal jump in real-time, which can precisely detect the GPS clock signal jump in real-time by using GPS carrier phase measurements when a GPS clock signal is suddenly jumped.

To achieve the object of the present invention, the present invention provides a method of detecting GPS clock signal jump, comprising a data obtaining step of obtaining precise satellite orbit from IGS and GPS carrier phase measurement from a GPS receiver to detect the GPS clock signal jump; a GPS clock bias calculating step of eliminating errors included in the data obtained from the data obtaining step and calculating GPS clock bias; a Teager energy calculating step of applying a Teager energy operator to the GPS clock bias calculated with respect to each satellite in the GPS clock bias calculating step and calculating Teager energy in order to determine whether the GPS clock jump is occurred; and a GPS clock jump detecting step of checking whether a Teager energy obtained in the Teager energy calculating step is larger than a threshold value, and it is determined that the GPS clock jump is occurred if the Teager energy is larger than the threshold value.

### BRIEF DESCRIPTION OF THE DRAWINGS

FIG. 1 is a flow chart showing a method of detecting GPS clock signal jump according to the present invention.

FIG. 2 is a process chart performing the method of detecting the GPS clock signal jump according to the present invention.

FIG. 3 is block diagram showing a configuration for performing the detecting method in real-time according to the present invention.

FIG. 4a is a graph showing GPS clock bias calculated from PRN 30 satellite data obtained from the IGS.

FIG. 4b is a graph showing a residual of clock bias remained after drift effect is eliminated from the GPS clock bias of FIG. 4a.

FIG. 5a is a graph showing GPS clock bias estimated by applying the method of detecting the GPS clock signal jump of the present invention to PRN 30 satellite measurement obtained from PTB.

FIG. 5b is a graph obtained by applying Teager energy to FIG. 5a.

FIGS. 6a and 7a are graphs showing GPS clock biases estimated by applying the method of detecting the GPS clock signal jump of the present invention to PRN 32 and PRN 04 satellite measurements obtained from KRISS and USNO.

FIGS. 6b and 7b are graphs obtained by applying the Teager energy to FIGS. 6a and 7a.

### DESCRIPTION OF SPECIFIC EMBODIMENTS

The advantages, features and aspects of the invention will become apparent from the following description of the embodiments with reference to the accompanying drawings, which is set forth hereinafter.

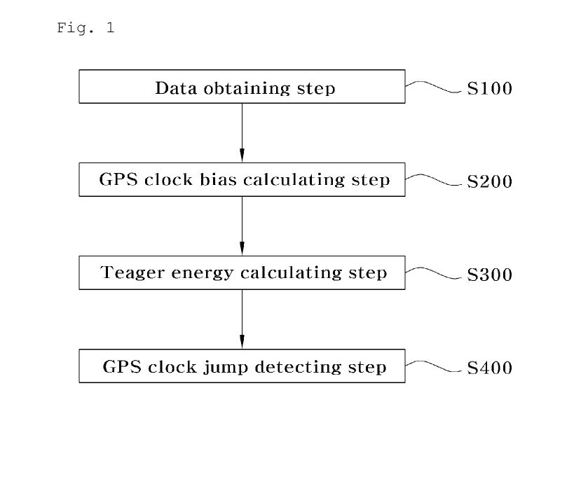

The present invention is to rapidly and precisely detect GPS clock signal jump in real-time. As shown in FIG. 1, the present invention includes a data obtaining step S100, a GPS clock bias calculating step S200, a Teager energy calculating step S300 and a GPS clock jump detecting step S400.

(1) Data Obtaining Step S100

This step is to collect data necessary to detect the GPS clock jump from a GPS receiver steering an atomic clock in time transfer institutes and IGS (International GNSS Service) respectively. The data collected in the step includes GPS carrier phase measurements with respect to each navigation satellite received from the GPS receiver and ultra-rapid orbit of the satellite provided from the IGS.

GPS signal received in the GPS receiver provides two types of code phase and carrier phase measurements. Generally, since code phase data includes larger measurement error than carrier phase data, it is possible to more precisely detect the GPS clock jump by using the carrier phase data. Therefore, the present invention uses the carrier phase measurements.

(2) GPS Clock bias Calculating Step S200

In order to efficiently detect GPS clock anomaly, it is necessary to estimate GPS clock bias. The carrier phase measurements obtained in the data obtaining step S100 and stored in a computer memory include errors caused by various reasons as well as the GPS clock bias. Therefore, in this step, the various errors included in the previously obtained data are eliminated through a computer, thereby calculating a GPS clock error, i.e., the GPS clock bias Bⁱ. The GPS carrier phase measurements Φ_{L1} and Φ_{L2} of an i^{th} satellite can be expressed by an equation 1, as follows:

Φ_{L1}=ρ+c(B_{A}−Bⁱ)−I_{L1}+Tλ_{L1}N_{L1}+ε_{Φ}_{_{L1}}

Φ_{L2}=ρ+c(B_{A}−Bⁱ)−I_{L2}+T+λ_{L2}N_{L2}+ε_{Φ}_{_{L2}} [Equation 1]

wherein Φ_{L1} and Φ_{L2} are phase measurement of each carrier L1 and L2, ρ is a distance between the satellite i and the receiver A, c is the velocity of light, B_{A} and Bⁱ are receiver clock bias and GPS clock bias, I and T are ionosphere and troposphere propagation delays, respectively, N and λ are an integer ambiguity and a wave length of the carrier L1 and L2, and ε is receiver measurement noise.

In the equation 1, the ionosphere propagation delay 1 is delay phenomenon of a receiving signal in a signal route, which is affected by the number of free electrons defined as TEC (Total Electron Content). Herein, the ionosphere propagation delay I can be modeled to be in inverse proportion to the square of a frequency f_{L} of a carrier L, as shown in equation 2.

$${I}_{L} = - \frac{40.3 T E C}{{f}_{L}^{2}} \qquad [ Equation 2 ]$$

wherein I_{L} is ionosphere propagation delay of the carrier L,

TEC is a total electron content in the path of a signal, and f_{L} is a frequency of the carrier L.

In case of using a single frequency receiver, the ionosphere propagation delay 1 can be estimated, for example, by using a Klobuchar ionosphere model. Herein, an ionosphere error can be corrected to about 50%. However, in case of using a dual frequency measurement, the ionosphere propagation delay 1 of the carrier phase measurement can be eliminated more efficiently. Thus, in the present invention, in order to eliminate the ionosphere propagation delay 1 through the computer, a value expressed by below equation 3 in which the dual frequency measurements is linearly combined as the carrier phase measurement Φ_{L}.

$${Φ}_{L} = \frac{1}{{f}_{L 1}^{2} - {f}_{L 2}^{2}} [ {f}_{L 1}^{2} {Φ}_{L 1} - {f}_{L 2}^{2} {Φ}_{L 2} ] \qquad [ Equation 3 ]$$

wherein Φ_{L} is a carrier phase measurement in which the effect of the ionosphere propagation delay is eliminated, f_{L 1} and f_{L2} are a frequency of each carrier L1 and L2, respectively, and Φ_{L1} and Φ_{L2} are phase measurement of each carrier L1 and L2.

Meanwhile, in the equation 3, it is required to calculate the troposphere propagation delay T with respect to a signal of the satellite i. As a model for calculating the troposphere propagation delay T, there are a Saastamoinen model, a Hophfield model, a Magnavox model, a Collins model and so on. In the Collins model, since five meteorological factors such as pressure, temperature, water vapor pressure, temperature change rate and varying velocity of water vapor are considered according to seasonal change, latitude and height of the receiver in order to estimate the distance delay, it is possible to obtain the more precise troposphere propagation delay than in other models. Therefore, in order to estimate the troposphere propagation delay T in the computer, the present invention uses the Collins model which is expressed by equation 4 as follows:

$$ξ ( φ , D ) = {ξ}_{0} ( φ ) - Δξ ( φ ) cos ( \frac{2 π ( D - {D}_{min} )}{365.25} ) \qquad [ Equation 4 ]$$

wherein ξ is the function with respect to each meteorological factor (pressure, temperature, water vapor pressure, temperature change rate and varying velocity of water vapor), which is determined by the latitude φ and day-of-year D, and ξₒ and Δξ are an average of each receiver according to the latitude and a change of each receiver according to the season. Herein, Dₘᵢₙ is 28 in the northern hemisphere and 211 in the southern hemisphere.

In the equation 3, when measuring a distance ρ from the satellite i to the receiver A, an error of satellite position may be generated by the inaccuracy of satellite orbit. Particularly, since the satellite orbit according to a navigation message included in the signal received to the satellite has an accuracy of about 100 cm, the accuracy is deteriorated. Therefore, when calculating the position of satellite, the present invention uses the ultra-rapid orbit provided from the IGS and having an accuracy of about 5 cm, instead of the satellite orbit included in the navigation message received from the receiver. Since the GPS receiver generally uses a lower grade oscillator, the receiver clock bias is the largest one of error factors causing the GPS error. The receiver clock bias (error) can be compensated by obtaining the measurements received from other satellite. However, in case that the receiver clock is synchronized with an atomic clock having the high accuracy, it is possible to more effectively eliminate the receiver clock bias. Therefore, the present invention uses the data received from the receiver of which the clock is synchronized with the atomic clock, and thus when determining the GPS clock bias Bⁱ, it is possible to considerably reduce the influence of the receiver clock error.

And since the receiver measurement noise cannot be expressed by a certain model, the present invention uses the carrier phase measurement which has less measurement noise than the code phase measurement, and thus it is possible to enhance the accuracy of the detecting method according to the present invention. After the errors such as the ionosphere and troposphere propagation delays I and T, the distance ρ from the satellite i to the receiver A and the receiver clock bias B_{A} are calculated in the equation 1 through the processes as described above, the GPS clock bias Bⁱ can be calculated through the computer using equation 5 as follows:

cBⁱ=Δρ+cΔB_{A}+ΔT+N_{L}+ε_{φ}_{_{L}} [Equation 5]

wherein c is the velocity of light, Bⁱ is the GPS clock bias, ΔΣ is an actual distance from the receiver A to the satellite i and a calculation error, ΔB_{A} is a compensation error of the receiver clock bias, ΔT is a compensation error of the troposphere propagation delay remained after being eliminated by the model, N_{L} is an integer ambiguity of the carrier wave L and ε_{Φ}_{_{L}} is the carrier phase measurement noise of the receiver.

Herein, the integer ambiguity N_{L} of the carrier wave L in the equation 5 can be expressed by equation 6 as follows:

$${N}_{L} = \frac{{cf}_{L 1} {N}_{L 1 -} {cf}_{L 2} {N}_{L 2}}{{f}_{L 1}^{2} - {f}_{L 2}^{2}} \qquad [ Equation 6 ]$$

wherein N_{L} is an integer ambiguity of the carrier wave L, c is a proportional constant, f_{L1} and f_{L2} are a frequency of each carrier wave L1 and L2, respectively, and N₁ an N_{L1} and N_{L2} are an integer ambiguity of each carrier wave L1 and L2, respectively.

(3) Teager Energy Calculating Step S300

In order to determine whether the GPS clock jump is occurred, the step is to calculate the Teager energy for the GPS clock signal with respect to each navigation satellite, thereby calculating its size.

If the GPS clock bias is calculated in the GPS clock bias calculating step S200, the calculated GPS clock bias Bⁱ is substituted into a Teager energy formula with respect to a discrete time to be described later, thereby calculating the Teager energy. As a result, if the calculated Teager energy becomes larger than a predetermined value, the change in the Teager energy may be regarded as that occurred by the GPS clock signal jump.

Teager and Kaiser proposed a nonlinear operator in order to measure energy of a signal which has a single component and is continuously oscillating, and the nonlinear operator can be expressed with respect to a continuous time and a discrete time by equations 7 and 8 as follows:

E_{c}[x(t)]=x^{′2}(t)−x(t)″x(t) [Equation 7]

wherein E_{c} is the Teager energy with respect to the continuous time, and x(t) is a displacement of oscillation signal at a time t.

E_{D}[x(t)]=x^{′2}(n)−x(n−1)x(n+1) [Equation 8]

wherein E_{D} is the Teager energy with respect to the discrete time, x(n), x(n−1) and x(n+1) are a sample value of the signal at a time n, n−1 and n+1, respectively.

An object having a mass of m which is suspended by a spring of force constant k and moved can be expressed by equation 9 as follows:

(x(t)=Acos (wt+φ) [Equation 9]

wherein x(t) is a displacement at a time t, A is an amplitude, w is each frequency which is the same as (k/m)^{1/2}, and φ is initial phase of the object.

Total energy of the object which is the sum of kinetic energy and potential energy can be expressed by equation 10. If the equation 9 is substituted into the equation 10, the total energy of the object having the mass of m is in proportion to the square of each frequency w and the square of the amplitude A-, respectively, as shown in equation 11.

$$E = \frac{1}{2} {kx}^{2} + \frac{1}{2} m {\dot{x}}^{2} \qquad [ Equation 10 ]$$

wherein E is total energy of the object, k is a spring force constant, m is a mass of the object, and x is a displacement of the object.

$$E = \frac{1}{2} {mwA}^{2} \approx {w}^{2} {A}^{2} \qquad [ Equation 11 ]$$

wherein E is total energy of the object, m is a mass of the object, w is each frequency, and A is an amplitude.

In the discrete time, assuming that x(n) is a sample value of a signal, which shows the motion of the object, the sample value at a sampling time n, n−1 and n+1 can be expressed by equation 12 as follows:

x(n)=Acos(Ωn+φ)

x(n−1)=Acos[Ω(n−1)+φ]

x(n+1)=Acos[Ω(n+1)+φ] [Equation 12]

wherein x(n) is a sample value of the signal at the sampling time n, A is an amplitude, Ω is each frequency, and φ is initial phase of the object.

If the equation 12 is substituted into the equation 8, equation 13 will be obtained. Thus, it will be understood that the energy having a certain single component is in proportion to the square of the amplitude A and the square of each frequency Ω, respectively, as shown in equation 12. Therefore, if values in which the square of the amplitude A and the square of each frequency Ω are multiplied are calculated continuously and then observed, they becomes relatively larger when the GPS clock jump is occurred and thus it is possible to easily detect the GPS clock jump.

E_{D}[x(t)]=x^{′2}(n)−x(n−1)x(n+1)=A ² sin²(Ω)≈A ²Ω² [Equation 13]

If the Teager energy operator with respect to the discrete time expressed by the equation 13 through the computer is applied to the GPS clock bias Bⁱ in which the error is eliminated from the signal received from the GPS satellite by using the equation 5, the quantified Teager energy can be obtained. And if the Teager energy is calculated while changing the sampling time, it is further possible to obtain the Teager energy before and after.

Herein, if the amplitude A and the frequency Ω of the GPS clock signal are changed, the Teager energy is also changed. Therefore, when the GPS clock signal is changed by the anomaly such as the GPS clock jump, it is possible to easily detect the anomaly by observing the Teager energy.

(4) GPS Clock Jump Detecting Step S400

In The step, if the Teager energy is calculated through the Teager energy calculating step S300, the GPS clock signal jump is detected through the value of the Teager energy. This step is carried out by the computer.

When the Teager energy is calculated by applying the Teager operator to the GPS clock bias measurement, the Teager energy is calculated within the desired extent while the GPS clock signal jump is not occurred, but the Teager energy becomes larger suddenly while the GPS clock signal jump is occurred. Therefore, in the present invention, it is determined whether the calculated Teager energy is larger than a threshold value, and if the Teager energy is larger than the threshold value, this is regarded as that occurred by the GPS clock signal jump.

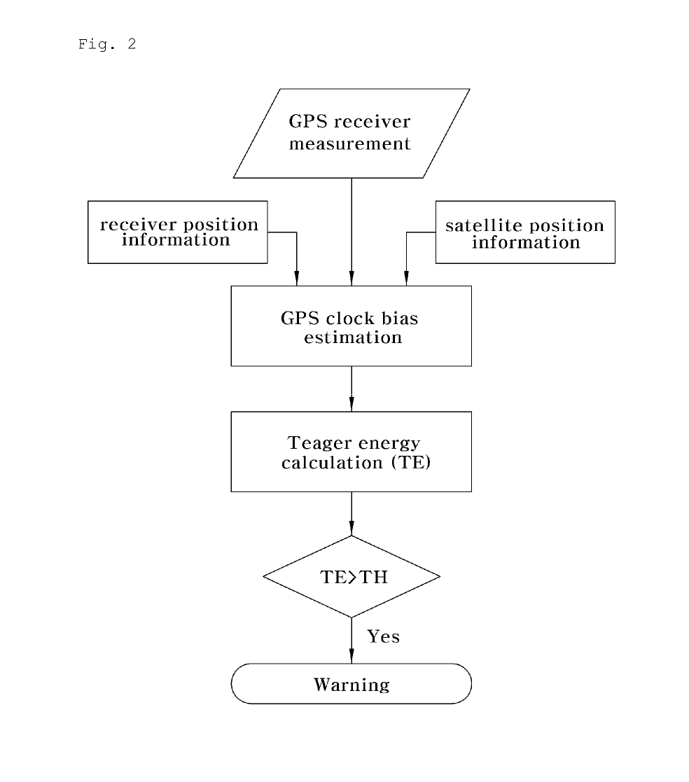

The inventors have performed the test using a test device as shown in FIG. 3 in order to verify the validity of the method of detecting the GPS clock jump according to present invention, as described above, and check whether the GPS clock jump can be detected in real-time. Hereinafter, the test processes will be described.

First of all, the test for verifying the validity of the method of detecting the GPS clock jump according to present invention will be described.

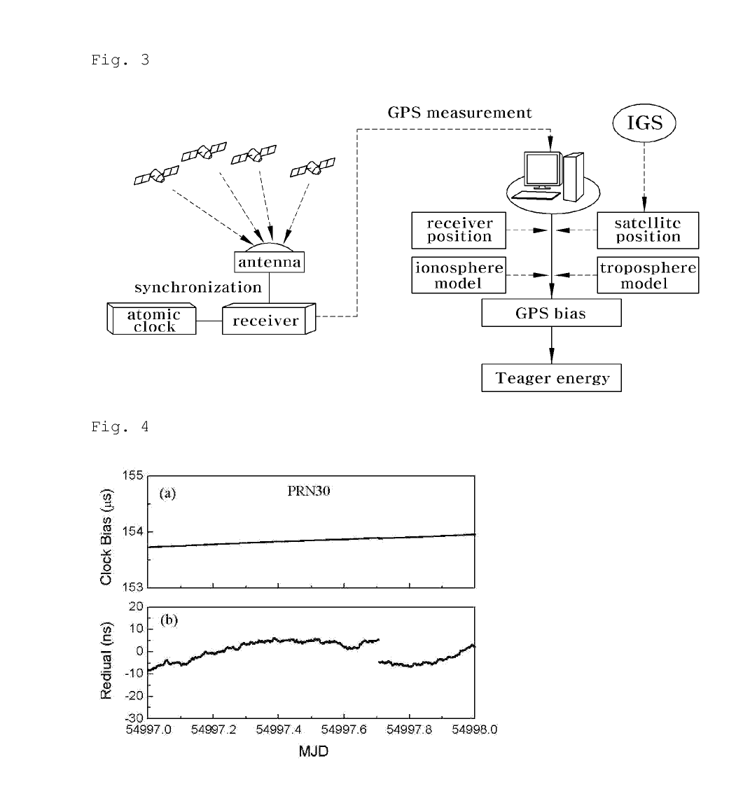

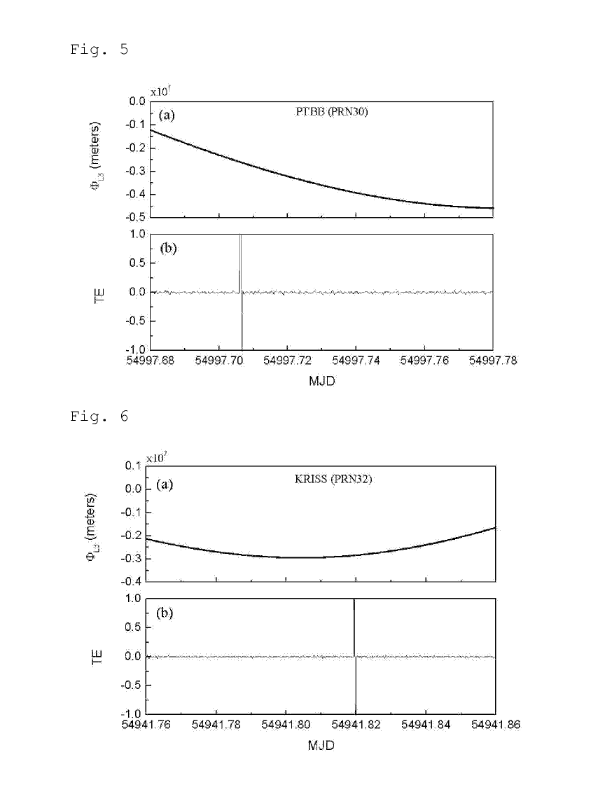

The data provided from the IGS were used as the GPS clock data for detecting the GPS clock signal jump. The IGS generates and provides clock information of each satellite and each observatory from data received from eight(8) analysis centers by applying a weighted average. The precise GPS satellite clock information generated from the IGS is decided on the basis of IGS time which is linearly tuned with respect to GPS time. In this test, the present invention used satellite clock information having an interval of 30 seconds and formed into a CLOCK RINEX format. Since the information cannot be used in real-time but includes precise information of the GPS clock anomaly, the GPS clock data provided from the IGS through the Internet is researched in order to catch a satellite in which the GPS clock jump is occurred and a point of time when the GPS clock jump is occurred. The result thereof is shown in FIGS. 4a and 4b.

FIG. 4a is a graph showing GPS clock bias calculated from PRN 30 satellite data obtained from the IGS, and FIG. 4b is a graph showing a residual of clock bias remained after drift effect is eliminated from the GPS clock bias of FIG. 4a. In these graphs, it could be understood that the PRN 30 satellite had a clock drift of about 250 ns for a day and the GPS clock jump of about 9.8 ns was occurred around MJD 54997.71.

Then, the test for checking whether the GPS clock jump occurred in the same satellite (PRN 30) can be detected by using the detecting method of the present invention will be described.

In order to check whether the GPS clock anomaly can be detected in real-time, the GPS data observed at the point of time when the GPS signal jump is occurred is acquired and then the detecting method of the present invention is applied to the observed data from the satellite in which the GPS signal jump is occurred. At this time, the GPS data having the confirmed GPS clock signal jump are obtained through the Internet from time transfer institutes of KRISS (Korea Research Institute of Standards and Science) in Korea, USNO(US Naval Observatory) in the U.S.A. and PTB(Physikalisch-Technische Bundesanstalt) in Germany.

Herein, the receiver clock is synchronized with an atomic clock which is the same grade as the GPS atomic clock, and the position of the receiver is determined using predetermined coordinates by using a precise positioning method, and the position of the satellite is determined by using the IGS ultra-rapid orbit.

Since the initial integer ambiguity of the carrier phase functions as an offset in the GPS clock, it is not considered. Herein, an initial offset of the GPS clock bias is set to 0(zero), and a choke ring is provided at an antenna in order to reduce an error due to multi-route of the satellite signal. Thus since the error due to the multi-route is reduced, it is not considered.

The errors such as the distance P from the satellite i to the receiver A, the receiver clock bias B_{A} and the ionosphere and troposphere propagation delays 1 and T are eliminated in the GPS data obtained from the KRISS, USNO and PTB through the computer, and then the GPS clock bias Bⁱ is calculated. In the result of calculating the Teager energy with respect to the GPS clock bias Bⁱ, it is observed that the Teager energy becomes larger suddenly around the part (MJD 54997.71) that the GPS clock signal jump is occurred, and the result is the same as that of FIG. 4b.

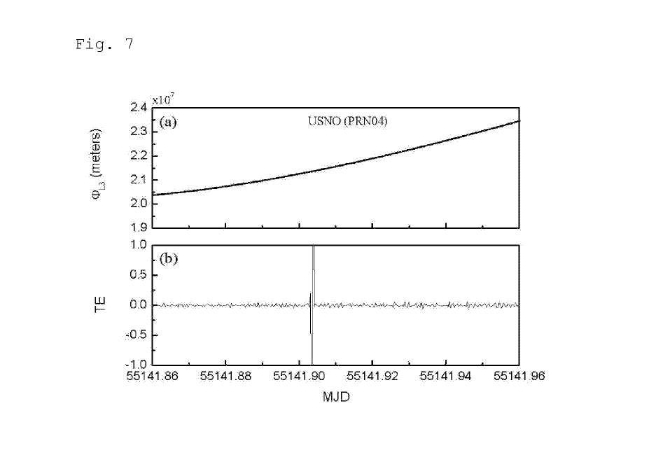

FIGS. 6 and 7 are graphs showing results that the detecting method of the present invention is applied to other satellites such as PRN 32 and PRN 04. It is confirmed that the result of the test is also coincided with the GPS event information provided in the IGS. Therefore, it is proven that the present invention can precisely detect the GPS clock signal jump in real-time.

According to the present invention, since the Teager energy is applied to the GPS clock bias generated by processing the carrier phase measurements obtained in real-time, it is possible to precisely detect the GPS clock signal jump in real-time.

Further, due to the nonlinear operator (Teager energy) which can express the complicated function including two or more functions into the simple energy function, it is possible to easily estimate the change even in the complex signal having various shapes, such as in the GPS clock. Therefore, it is possible to easily and efficiently detect the GPS clock signal jump.

While the present invention has been described with respect to the specific embodiments, it will be apparent to those skilled in the art that various changes and modifications may be made without departing from the spirit and scope of the invention as defined in the following claims.

1. A method of detecting GPS clock signal jump, comprising:
a data obtaining step S100 of obtaining GPS carrier phase measurements from a GPS receiver and precise satellite orbits from IGS to detect the GPS clock signal jump;
a GPS clock bias calculating step S200 of eliminating errors included in the data obtained from the data obtaining step S100 and calculating GPS clock bias Bⁱ;
a Teager energy calculating step S300 of applying a Teager energy operator to the GPS clock bias Bⁱ calculated with respect to each satellite in the GPS clock bias calculating step S200 and calculating Teager energy in order to determine whether the GPS clock jump is occurred; and
a GPS clock jump detecting step S400 of checking whether a Teager energy obtained in the Teager energy calculating step S300 is larger than a threshold value, and it is determined that the GPS clock jump is occurred if the Teager energy is larger than the threshold value.

2. The method of claim 1, wherein the carrier phase measurement Φ_{L} used to eliminate an error due to ionosphere propagation delay 1 in the GPS clock bias calculating step S200 is a value expressed by equation 3 in which dual frequency measurements are linearly combined:
$${Φ}_{L} = \frac{1}{{f}_{L 1}^{2} - {f}_{L 2}^{2}} [ {f}_{L 1}^{2} {Φ}_{L 1} - {f}_{L 2}^{2} {Φ}_{L 2} ] \qquad [ Equation 3 ]$$
wherein Φ_{L} is a carrier phase measurement in which the effect of the ionosphere propagation delay is eliminated, f_{L1} and f_{L2} are a frequency of each carrier L1 and L2, respectively, and Φ_{L1} and Φ^{L2} are phase measurement of each carrier L1 and L2.

3. The method of claim 1, wherein an error due to troposphere propagation delay T in the GPS clock bias calculating step S200 is calculated by using Collins model expressed by equation 4 as follows:
$$ξ ( φ , D ) = {ξ}_{0} ( φ ) - Δξ ( φ ) cos ( \frac{2 π ( D - {D}_{min} )}{365.25} ) \qquad [ Equation 4 ]$$
wherein ξ is the function with respect to each meteorological factor, which is determined by the latitude φ and day-of-year D, and ξₒ and Δξ are are an average of each receiver according to the latitude and a change of each receiver according to the season.

4. The method claims 1, wherein the data used in the GPS clock bias calculating step S200 are data received from a receiver synchronized with an atomic clock.

5. The method of claim 2, wherein the data used in the GPS clock bias calculating step S200 are data received from a receiver synchronized with an atomic clock.

6. The method of claim 3, wherein the data used in the GPS clock bias calculating step S200 are data received from a receiver synchronized with an atomic clock.
